(19) United States
(12) Patent Application Publication
(10) Pub. No.: US 2010/0163128 A1
(43) Pub. Date: Jul. 1, 2010

(54) HYDRAULIC DIRECTIONAL VALVE

(75) Inventors: Markus Kinscher, Adelsdorf (DE); Jens Hoppe, Erlangen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/063,038

(22) PCT Filed: Aug. 4, 2006
(86) PCT No.: PCT/EP06/07726

§ 371 Date: Feb. 6, 2008

(30) Foreign Application Priority Data
Sep. 1, 2005 (DE) 102005041395.1

(51) Int. Cl. F15B 13/043; F15B 13/08; F16K 27/02; B21D 51/16

(52) U.S. Cl. 137/625.64; 137/596.18; 91/430; 251/366; 29/890.124

(57) ABSTRACT

A hydraulic directional valve having an electromagnetic actuating unit and a valve section, an essentially cylindrical, blind hole-like receptacle being formed on one component of the actuating unit, a flange section of a valve housing of the valve section engaging in the receptacle, the flange section being provided with an angular groove which extends in a circumferential direction, and an essentially hollow cylindrical wall of the receptacle in the region of the annular groove engaging in said annular groove in such a way that it bears on the groove base of the annular groove, along the entire circumference of said annular groove. The torsional rigidity between the flange section and the wall is increased. In this context, particular emphasis is placed on processing reliability and economic viability of the connecting process.

### BACKGROUND

The invention relates to a hydraulic directional valve with an electromagnetic actuating unit and a valve section, with an essentially cylindrical, blind hole-like receptacle being formed on one component of the actuating unit, with a flange section of a valve housing of the valve section engaging in the receptacle, with the flange section being provided with an annular groove extending in a circumferential direction, and with an essentially hollow, cylindrical wall of the receptacle in the region of the annular groove engaging in this annular groove, such that this wall contacts the groove base of this annular groove along the entire circumference of the annular groove. In addition, a method for producing such a control valve is provided.

Such directional valves are used in internal combustion engines, for example, for controlling hydraulic camshaft adjusters or switchable cam followers. The directional valves are made from an electromagnetic actuating unit and a valve section. The valve section represents the hydraulic section of the directional valve, with at least one supply port, at least one working port, and a tank port also being formed on this valve section. Certain ports of the valve section can be selectively connected to each other hydraulically via the electromagnetic actuating unit and thus the pressure medium flows can be directed.

For the use of a directional valve for controlling a camshaft adjuster, this is formed in the normal case as a 4/3 proportional directional valve. Such a proportional valve is disclosed, for example, in DE 199 56 160 A1. The electromagnetic actuating unit is comprised in this case from a first magnetic yoke, a coil, a second magnetic yoke, a housing, an armature, and a connection element, which holds an electrical plug connection that is used for supplying power to the coil.

The valve section is made from a valve housing and a control piston arranged displaceable in the axial direction in this housing. The valve housing is arranged within a cylindrical, blind hole-like receptacle of the second magnetic yoke and is connected fixed in position with this magnetic yoke. Four annular grooves, which are used as pressure medium ports, are formed on the outer casing surface of the valve housing. Openings, through which pressure medium can be led into the interior of the valve housing, are formed in the groove bases. In the interior of the valve housing, a control piston is arranged axially displaceable, wherein the outer diameter of the control piston is adapted to the inner diameter of the valve housing. In addition, annular grooves, via which pressure medium ports can be connected to each other, are similarly formed on the control piston.

The coil and the first and second magnetic yokes are arranged coaxial with respect to each other within the housing of the electromagnetic actuating unit. The first and the second magnetic yokes are here offset with respect to each other in the axial direction. In the region between the first and the second magnetic yokes there is the armature radially within the magnetic yokes, with this armature being surrounded by the coil in the radial direction. The armature, the housing and the first and second magnetic yokes form a flow path for the magnetic flux lines caused by the coils being energized.

By energizing the coils, the armature is forced in the direction of the second magnetic yoke, with this motion being transmitted to the control piston by a tappet rod attached to the armature. This piston is now moved in the axial direction against a spring supported on the valve housing.

Directional valves for controlling switchable cam followers are mostly constructed as switch valves. Such a switch valve is known from a setup as a 3/2 switch valve, for example, from DE 103 59 363 A1. The electromagnetic actuating unit is comprised, in turn, from a housing, an armature, a connection element and a first and a second magnetic yoke. The function and the construction of the electromagnetic actuating unit are in wide parts analogous to that of the proportional valve.

In this case, a supply port, a working port, and a tank port are formed on the valve section. The working port communicates via each opening constructed as a valve seat both with the supply port and also with the tank port. Within the valve housing there is furthermore a control piston, on which two closing elements are formed. Each closing element can block or open the pressure medium flow through one of the valve seats as a function of the position of the control piston within the valve housing. The working port can be connected selectively to the supply port or to the tank port as a function of the axial position of the control piston. The axial position of the control piston is here fixed, in turn, by the axial position of the armature relative to the second magnetic yoke.

A flange section of the valve housing of the directional valve disclosed in DE 199 56 160 A1 is arranged within a cylindrical, blind hole-like receptacle. The receptacle is a hollow cylindrical projection constructed in one piece with a magnetic yoke of the electromagnetic actuating unit. In this way, a thin-walled, end section of the projection engages radially in an annular groove formed on the valve housing along its entire periphery. Through this connection, the valve housing is fixed in the axial direction relative to the actuating unit. The connection opposes functionally secure high axial pull-off forces, which occur during the (dis-)assembly or during the operation of the internal combustion engine.

The torsional rigidity of such a connection depends decisively on the joining forces during the production of the connection. To increase torsional rigidity, it is also provided to produce the connection through toothed crimping of the thin-walled section. For this purpose, a matrix provided with teeth is used to force the thin-walled section into the annular groove. Here, in the region of the teeth, the thin-walled section is forced into the valve housing, with a positive-fit connection being produced in the circumferential direction.

For producing this connection, large forces acting radially are needed, increasing the expense for producing the connection. Forces that are too low lead to insufficient rigidity of the connection of the two components. During the service life of the component, a reduction in the torsional rigidity and thus rotation of the valve housing relative to the actuating unit can result due to axial forces, rocking moments or torques acting during the assembly or disassembly or due to vibrations during the operation of the internal combustion engine or thermal setting. This can lead to interruptions in function of the directional valve and thus the component to be controlled by the directional valve in applications, in which a fixed angular reference is needed between a valve bracket, by which the directional valve is fixed to a surrounding construction, and the valve section.

Forces that are too high can lead to the valve housing being damaged and thus also to interruptions in function.

### SUMMARY

Therefore, the invention is based on the objective of avoiding these mentioned disadvantages and thus creating a hydraulic directional valve, whose valve section is locked in rotation with its actuating unit. Here, the assembly expense should be reduced or at least not increased. Furthermore, the production costs of the directional valve should not be negatively affected by these measures.

According to the invention, the objective is met in that the groove base of the annular groove has external contours deviating from a circular form in cross section.

The flange section of the valve housing is held in a cylindrical receptacle of a component of the actuating unit. The receptacle can be formed, for example, by an open end of a housing or a hollow cylindrical projection of a magnetic yoke. Here, the external diameter of the flange section is advantageously adapted to the inner diameter of the wall bounding the receptacle, through which the valve housing is centered radially with respect to the actuating unit.

The flange section is provided with an annular groove extending in the circumferential direction, in which a thin-walled section of the wall of the receptacle engages in such a way that the flange section contacts the groove base of the annular groove. Here, the wall can engage in the annular groove axially at the end or with a middle section.

During assembly, the flange section of the valve housing is positioned in the receptacle. Here, this contacts the base of the receptacle in the axial direction. In a next step, the wall is deformed, for example, by a fixing, rolling, or orbital forging method in the annular groove. Another possibility comprises producing the connection by an axial crimping method. In this case, the valve housing is positioned, in turn, in the receptacle. In a subsequent step, a hollow cylindrical plunger engages over the valve housing, with this being shifted in the axial direction up to the annular groove. The axial opening of the plunger has a conical or rounded construction, wherein its inner diameter has a smaller construction than the outer diameter of the wall. Through further axial shifting of the plunger, the wall of the receptacle is forced into the annular groove and thus the connection between the valve housing and the actuating unit is created.

During the deformation of the wall, material is forced into the areas of the groove base which deviates from the circular form. Through the resulting positive fit in the peripheral direction, the torsional rigidity of the connection increases significantly in comparison to embodiments with a circular groove base. In the case of embodiments with bulges deviating from the circular form, the material of the wall nestles against these bulges, whereby, in turn, a positive-fit connection in the peripheral direction is created.

Through this construction of a hydraulic directional valve, a connection with outstanding torsional rigidity between the valve housing and the actuating unit is produced. The connection withstands significantly higher moments, which result from forces or moments acting on the individual components. Likewise, the risk of the connection becoming loose due to thermal setting is eliminated. Furthermore, the connection of the components can be produced more easily and functionally more secure.

The joining forces can be significantly reduced, because the torsional rigidity results not exclusively from the non-positive fit between the wall and the valve housing. Therefore, there is reduced risk that the valve housing or the housing or the magnetic yoke of the actuating unit will be damaged.

Just as little material of the valve housing must be displaced by material of the wall during the joining process, whereby the exact positioning of the components and their dimensional accuracy are no longer taken into consideration. Consequently, the processing reliability of the assembly process increases. The reduction of the joining forces and the increase of the process reliability lead to lower production costs of the directional valves.

In one embodiment, the groove base is formed with an essentially circular cross section, wherein at least one indentation is provided in the groove base.

Alternatively it can be provided to form the groove base with an essentially circular cross section, wherein at least one bulge is provided in the groove base.

Through these measures, a positive-fit connection can also be formed in addition to the non-positive fit in the circumferential direction.

In one embodiment of the invention, it is proposed that the groove base has an essentially circular cross section, wherein at least one chord-like section is provided. During the production of the connection, the material of the wall is displaced against the outer circumferential surface of the groove base, with this also coming into contact with the chord-like section and in this way producing the positive-fit connection. Such chord-like sections can be produced easily and economically, for example, through milling or, in the case of valve housings produced by means of an injection molding process, through corresponding shapes of the injection mold. In addition to the formation of one chord-like section, also several such sections can be produced.

Alternatively, it can be provided, for example, to form radial teeth on the groove base with an essentially circular cross section. During the production of the connection, material of the wall is displaced into the intermediate spaces of the teeth, wherein the formation of micro-teeth on the groove base already generates sufficient torsional rigidity.

Furthermore, a method for producing a directional valve according to claim 1 is provided with the following method steps:
positioning the valve housing within the cylindrical receptacle, and
displacing material of the wall into the annular groove.

In this way, for producing the connection between the valve housing and the actuating unit, a section of the wall of the receptacle can be forced into the groove base by an axial crimping method, a fixing method, rolling, or a orbital forging method.

Furthermore, it is possible to form the groove base with an essentially circular cross section, wherein at least one chord-like section is proposed on the groove base or radial teeth are formed.

This type of production of the connection between the valve housing and the actuating unit represents a process-reliable and economic method.

### BRIEF DESCRIPTION OF THE DRAWINGS

Additional features of the invention emerge from the following description and from the drawings, in which embodiments of the invention are illustrated simplified. Shown are:

FIG. 1a a longitudinal section view through an actuating unit,

FIG. 1b a partial longitudinal section view through a hydraulic directional valve according to the invention,

FIG. 1c a partial longitudinal section view through another hydraulic directional valve according to the invention,

FIG. 2a a cross sectional view through the directional valve according to the invention from FIG. 1b along the line IIA-IIA,

FIG. 2b a cross sectional view through an alternative embodiment of the directional valve according to the invention from FIG. 1c along the line IIB-IIB.

### DETAILED DESCRIPTION OF THE PREFERRED EMBODIMENTS

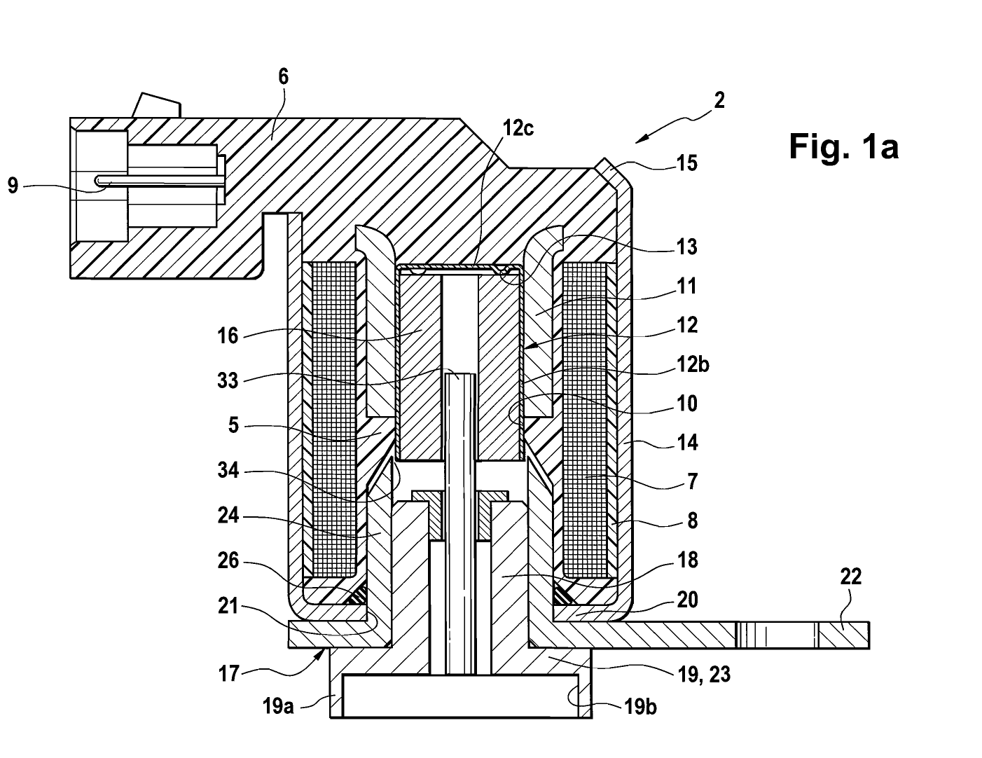

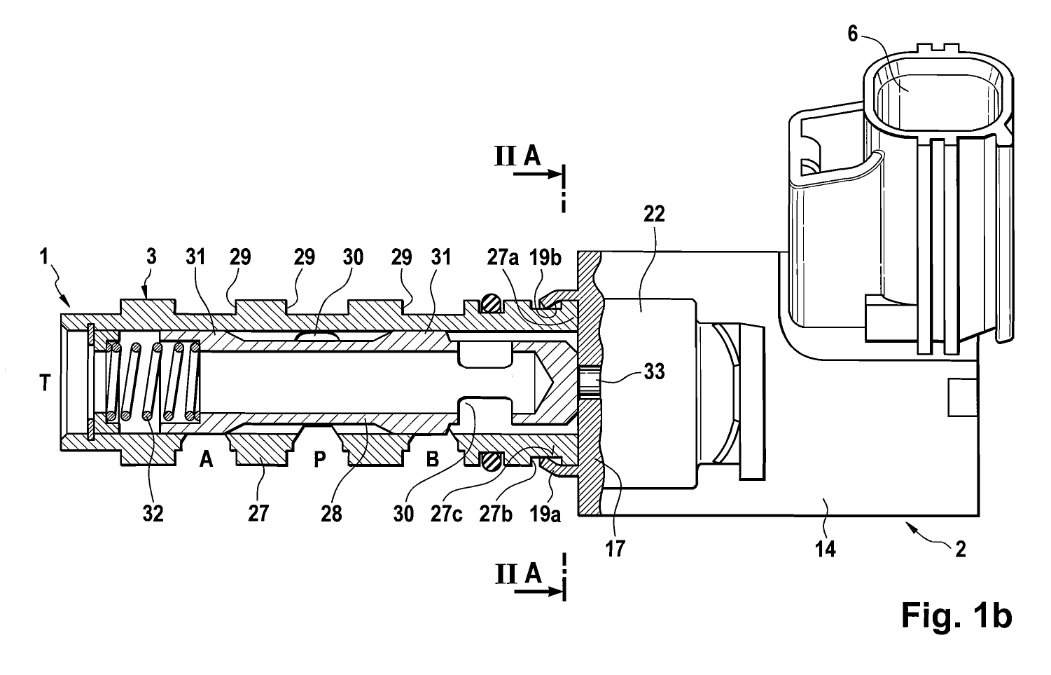

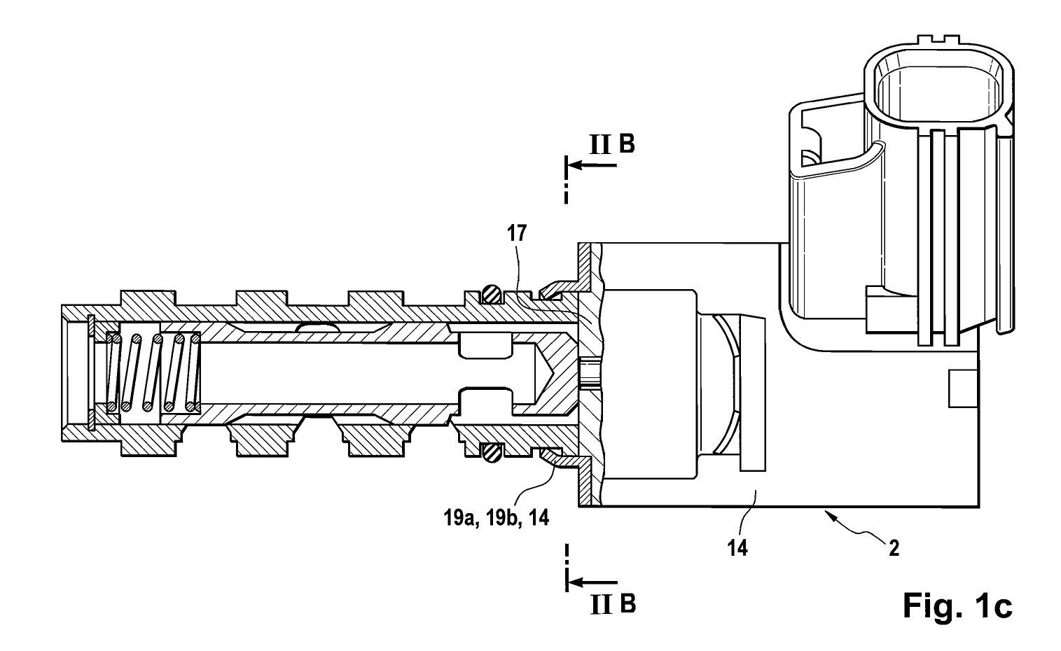

FIG. 1b shows a hydraulic directional valve 1 according to the invention in partial cross section using the example of a directional valve 1 constructed as a 4/3 directional proportional valve. The directional valve 1 comprises an actuating unit 2 and a valve section 3. Such directional valves 1 are used, for example, for controlling hydraulic camshaft adjusters. FIG. 1a shows a longitudinal section through an exemplary electromagnetic actuating unit 2.

The electromagnetic actuating unit 2 has a coil body 5 and a connection element 6 constructed in one piece with this coil body. The coil body 5 carries a coil 7 made from several windings of a suitable wire. The radially outer casing surface of the coil 7 is surrounded by a sleeve-shaped material layer 8, which is made from a non-magnetizable material. The material layer 8 can be made, for example, from a suitable plastic and can be sprayed onto the wound coil 7. Within the connection element 6, an electrical plug connection 9 is held, by means of which the coil 7 can be connected to a current or voltage source.

The coil body 5 is constructed with an essentially cylindrical, blind hole-like recess 10, which is arranged concentric with respect to the coil 7. In addition, the coil body 5 and the connection element 6 hold a sleeve-shaped first magnetic yoke 11 on the base-side end of the recess 10. Within the recess 10, a pot-shaped armature-guidance sleeve 12 is arranged, wherein its outer contours are adapted to the inner contours of the recess 10. The thin-walled armature guidance sleeve 12 is made from a cylindrical section 12b, which is bounded by a sleeve base 12c. The sleeve base 12c is provided with axial stops 13 extending inwardly. The armature guidance sleeve 12 extends in the axial direction along the entire recess 10, wherein the recess at least partially surrounds the coil body 5 at its opening in the radial direction.

The coil body 5 is arranged within a pot-shaped housing 14. The open end of the housing 14 projects past the connection element 6 in the axial direction, and this element and thus the coil body 5 are fixed within the housing 14 by a crimped connection 15.

Within the armature guidance sleeve 12 there is an armature 16 displaceable in the axial direction. The displacement path of the armature 16 is bounded in one direction by the stops 13 and in the other direction by a second magnetic yoke 17.

The second magnetic yoke 17 has a tubular section 18 and a cylindrical wall 19a connecting to this section in the axial direction. The tubular section 18 extends through an opening 21 constructed in the base 20 of the housing 14 in the armature guidance sleeve 12 arranged in the recess 10 of the coil body 5. Here, the outer diameter of the tubular section 18 is adapted to the diameter of the opening 21. The inner diameter of the axial end of the tubular section 18, which faces the armature 16, has a larger construction than the outer diameter of the armature 16. Thus, the armature sinks into this section. In addition, the outer casing surface of the tubular section 18 tapers to a point in the direction of the armature 16.

The housing 14 is supported by a mounting flange 22 on the annular section 19. The mounting flange 22 is used for attaching the directional valve 1 to a not-shown surrounding construction.

In this embodiment, the second magnetic yoke 17 is made from two components, a pole core 23, and a sleeve-shaped projection 24 constructed in one piece with the mounting flange 22.

A sealing ring 26 is arranged between the tubular section 18 of the second magnetic yoke 17, the base 20 of the housing 14, and the armature guidance sleeve 12. In interaction with the armature guidance sleeve 12, this prevents pressure medium from penetrating into the electromagnetic actuating unit 2, as a rule motor oil, and reaching the coil body 5, by which this coil body is protected from damage due to the pressure medium.

A tappet rod 33 extends through the interior of the pole core 23 and is connected at one end to the armature 16.

In FIG. 1c, an alternative embodiment of a hydraulic directional valve 1 according to the invention is shown, which is in wide parts identical to the embodiment shown in FIG. 1b. In contrast, the receptacle 19b is constructed in this case by the wall 19a of an open end of the pot-shaped housing 14.

As can be seen in FIGS. 1b, 1c, the valve section 3 of the directional valve 1 constructed as a 4/3 directional proportional valve comprises a valve housing 27 and a control piston 28. The valve housing 27 is constructed as a separate component and is connected to the actuating unit 2. For this purpose, a flange section 27a, which is positioned in a receptacle 19b of the wall 19a, is formed on the valve housing 27. Here, the inner diameter of the wall 19a is adapted to the outer diameter of the flange section 27a.

An annular groove 27b, in which a section of the wall 19a engages, is constructed on the flange section 27a. Therefore, the valve housing 27 is fixed axially with respect to the second magnetic yoke 17 and thus to the actuating unit 2.

On the outer casing surface of the valve housing 27 there are several annular grooves 29, which communicate via recesses 30 formed in the groove bases of the annular grooves 29 with the interior of the essentially hollow, cylindrical valve housing 27. The annular grooves 29 and the opening facing away from the electromagnetic actuating unit 2 in the valve housing 27 are used as pressure-medium ports A, B, P, T. The middle annular groove 29, which is used as a feed port P, communicates via a not-shown pressure medium line with a similarly not shown pressure medium pump. The two outer annular grooves 29, which are used as working ports A, B, communicate with users, for example, each with a pressure chamber or a group of counteracting pressure chambers of a similarly not shown camshaft adjuster. The axial port (tank port) T communicates with a similarly not shown pressure medium reservoir.

Within the valve housing 27 there is the control piston 28 displaceable in the axial direction. Control sections 31 constructed as annular connecting pieces are formed on the outer casing surface of the control piston 28. The outer diameter of the control sections 31 is adapted to the inner diameter of the valve housing 27. Through suitable axial positioning of the control piston 28 relative to the valve housing 27, adjacent pressure medium ports A, B, P can be connected to each other. Each working port A, B not connected to the feed port P is simultaneously connected to the tank port T. In this way, pressure medium can be selectively fed to or discharged from the individual pressure chambers of the camshaft adjuster.

The control piston 28 is charged on one end with the force of a spring element 32 in the direction of the electromagnetic actuating unit 2. At the other axial end of the control piston 28 there is a tappet rod 33, which extends through a borehole of the second magnetic yoke 17 and is fixed in position with the armature 16.

In the non-energized state of the coil 7, the control piston 28 is forced in the direction of the electromagnetic actuating unit 2 due to the force of the spring element 32.

The housing 14, the first magnetic yoke 11, the armature 16, and the second magnetic yoke 17 are made from a magnetizable material, while the connection element 6, the tappet rod 33, the coil body 5, and the armature guidance sleeve 12 are made from a non-magnetizable material. Thus, by energizing the coil 7 within the electromagnetic actuating unit 2, a magnetic flux, which forces the armature 16 in the direction of the valve section 3, is established via the armature 16, the first magnetic yoke 11, the housing 14, the second magnetic yoke 17, and an air gap 34 located between the armature 16 and the second magnetic yoke 17. Therefore, the control piston 28 is shifted in the axial direction by the tappet rod 33 against the force of the spring element 32. Through suitable regulation of the current flowing in the coil 7, the control piston 28 can be adjusted into any position between two end stops relative to the valve housing 27, and thus the pressure medium flows to or from the pressure chambers of the camshaft adjuster are regulated.

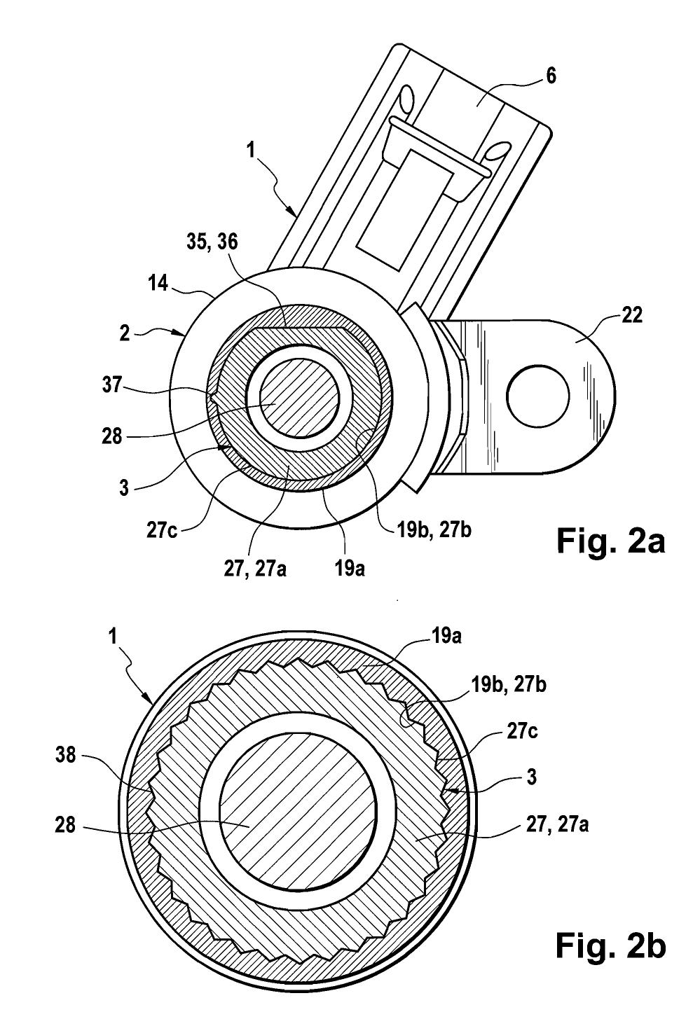

FIG. 2a shows a cross section along the line IIA-IIA through a first embodiment of a hydraulic directional valve 1 according to the invention from FIG. 1b. Essentially circular outer contours of a groove base 27c of the annular groove 27b have an indentation 35. The indentation 35 can be, for example, as shown in FIG. 2a, a chord-like section 36.

The material of the wall 19a engages in the annular groove 27b in such a way that this contacts the groove base 27c along the entire periphery of the annular groove 27b, that is, also on the boundary surface of the indentation 35. Thus, in the peripheral direction a positive-fit connection between the valve housing 27 and the actuating unit 2 is created. In addition to an indentation 35, naturally any number of indentations 35 can be formed.

Additionally or alternatively, a radially outward extending bulge 37 can be formed on the outer contours of the groove base 27c. During the production of the connection between the valve housing 27 and the wall 19a, the material of the wall 19a contacts the outer contours of the bulge 37, whereby a positive fit is produced in the peripheral direction.

The dimensions of the indentations or bulges 35, 37 shown in FIG. 2a and deviating from a circular form are shown excessively large for simplification. To achieve sufficient torsional rigidity, these can be formed considerably smaller.

Alternatively, it is also imaginable to form the groove base 27c of the annular groove 27b in cross section in a geometric shape, for example, elliptical, rectangular, or polygonal, deviating from the circular form.

FIG. 2b shows a cross section along the line IIB-IIB through a second embodiment of a hydraulic directional valve 1 according to the invention from FIG. 1c. The essentially circular outer contour of the groove base 27c of the annular groove 27b features teeth 38 extending in the radial direction.

The material of the wall 19a engages in the annular groove 27b in such a way that this contacts the groove base 27c along the entire periphery of the annular groove 27b. Thus, the material of the wall 19a engages in the teeth 38, via which a positive-fit connection between the valve housing 27 and the actuating unit 2 is created in the peripheral direction.

The radial dimensions of the teeth 38 shown in FIG. 2a is shown excessively large for clarification. To achieve sufficient torsional rigidity, micro-teeth can be formed on the groove base 27c.

The connection between the wall 19a and the valve housing 27 can be produced, for example, by a fixing, rolling, or orbital forging method.

It is also conceivable to produce the connection by an axial crimping method. For this purpose, the valve housing 27 is positioned in the receptacle 19b, with the valve housing 27 being centered radially by the wall 19a. In a subsequent processing step, an essentially hollow, cylindrical plunger is guided by the valve housing 27 until its axial end contacts the wall 19a. The hollow cylindrical plunger is provided with a rounding or a conical counter surface at its end turned toward the wall 19a. The plunger is charged with a defined force in the axial direction, whereby material of the wall 19a is forced into the annular groove 27b. By forcing the wall 19a into the annular groove 27b, a connection between the valve housing 27 and the housing 14 is achieved with a high axial pull-off resistance, with the flange section 27a coming into contact with the second magnetic yoke 17. Here, the force or the axial displacement is selected such that the material contacts the groove base 27c along the entire periphery of the annular groove 27b. Therefore, the positive-fit connection in the peripheral direction is produced with high torsional rigidity between the wall 19a and the valve housing 27, without there being the risk of damaging the housing 14 or the second magnetic yoke 17 or the valve housing 27.

### REFERENCE SYMBOLS

1 Directional valve
2 Actuating unit
3 Valve section
5 Coil body
6 Connection element
7 Coil
8 Material layer
9 Plug connection
10 Recess
11 First magnetic yoke
12 Armature guidance sleeve
12b Cylindrical section
12c Sleeve base
13 Stop
14 Housing
15 Crimped connection
16 Armature
17 Second magnetic yoke
18 Tubular section
19 Annular section
19a Wall
19b Receptacle
20 Base
21 Opening
22 Mounting flange
23 Pole core
24 Projection
26 Sealing ring
27 Valve housing
27a Flange section
27b Annular groove
27c Groove base
28 Control piston
29 Annular groove
20 Recesses
31 Control section
32 Spring element
33 Tappet rod
34 Air gap
35 Indentation
36 Chord-like section
37 Bulge
38 Teeth
P Feed port
T Tank port
A First working port
B Second working port

1. (canceled)

2. Hydraulic directional valve comprising:
an electromagnetic actuating unit and a valve section,
an essentially cylindrical, blind hole-like receptacle formed on a component of the actuating unit,
a flange section of a valve housing of the valve section engaging in the receptacle,
the flange section being provided with an annular groove extending in a peripheral direction, and
an essentially hollow, cylindrical wall of the receptacle engaging in a region of the annular groove, such that the wall contacts a groove base along an entire periphery of the annular groove,
the groove base of the annular groove has an outer contour deviating from a circular form in cross section.

3. Directional valve according to claim 2, wherein the groove base has an essentially circular cross section, with at least one indentation provided on the groove base.

4. Directional valve according to claim 2, wherein the groove base has an essentially circular cross section, with at least one bulge provided on the groove base.

5. Directional valve according to claim 2, wherein the groove base has an essentially circular cross section, with at least one chord-like section provided on the groove base.

6. Directional valve according to claim 2, wherein radial teeth are formed on the groove base which has an essentially circular cross section.

7. Method for producing a directional valve comprising:
providing an actuating unit with an essentially cylindrical, blind hole-like receptacle and a valve section with a valve housing having a flange for engaging in the receptacle, the receptacle having an essentially hollow, cylindrical wall,
positioning the valve housing within the cylindrical receptacle, and
forcing material of the wall into an annular groove in the flange section, the groove having a groove base with an outer contour that deviates from a circular form in the cross section.

8. Method for producing a directional valve according to claim 7, wherein one section of the wall of the receptacle is forced into the annular groove by an axial crimping method, a fixing method, rolling or an orbital forging method.

9. Method for producing a directional valve according to claim 7, wherein the groove base has an essentially circular cross section, with at least one chord-like section being provided on the groove base.

10. Method for producing a directional valve according to claim 7, wherein radial teeth are formed on the groove base which has an essentially circular cross section.
